(19) United States
(12) Patent Application Publication
(10) Pub. No.: US 2026/0049912 A1
(43) Pub. Date: Feb. 19, 2026

(54) ROOFING TROLLEY

(71) Applicant: John Fisk Stout, Cottonwood Heights, UT (US)

(72) Inventor: John Fisk Stout, Cottonwood Heights, UT (US)

(21) Appl. No.: 18/802,463

(22) Filed: Aug. 13, 2024

(51) Int. Cl. G01N 3/02; G01M 3/00; G01N 3/08

(52) U.S. Cl. CPC G01N 3/02; G01M 3/00; G01N 3/08

(57) ABSTRACT

A roofing trolley. There is: a carriage body, including a first pair of wheels spaced apart from each other, and positioned and sized to support the carriage body; and an axle disposed interior to the first pair of wheels; a probe mount coupled to the carriage body interior to the wheels, and including a bracket protruding therefrom; a seam probe functionally coupled to the bracket of the probe mount; and a handle extending from the carriage body and in functional communication with the seam probe such that actuation of the handle actuates pivoting of the seam probe.

### BACKGROUND OF THE INVENTION

### Field of the Invention

The present invention relates to roofing tools, specifically trolleys and seam probes for inspecting, repairing, and installing roofs.

### Description of the Related Art

In the related art, it has been known to use probes to test seams when inspecting roofing. A roof inspection is simply checking the overall condition of a roof. Its ultimate purpose is to determine if a roof is currently performing as expected, and if it isn't a roofer can make the appropriate recommendations.

Roofing inspectors will check roofing materials for signs of damage, such as cracks, splits, curling, and missing granules on shingles; cracks and chips on slate and tiles; and rust, corrosion, and split seams on metal roofs. An inspector will also look for signs of water damage and moss or algae buildup.

Often, test welds and seam probing are essential to ensure watertight seams and a roofing system that will provide long-term protection. Seam probes are the ideal roofing tool to detect defective seams, and make sure that roofing projects are completed correctly. In use, seam probes are simply passed along a welding line, and enough pressure is exerted to detect a fault in the seam.

Some improvements have been made in the field. Examples of references related to the present invention are described below in their own words, and the supporting teachings of each reference are incorporated by reference herein:

U.S. Pat. No. 8,820,605, issued to Frederick E. Shelton IV, discloses a surgical instrument. Various embodiments of the surgical instrument include an end effector that has a moveable cutting implement. A main drive shaft assembly operably interfaces with the end effector for transmitting an actuation motion to the movable cutting implement therein. A gear drive train is connected to the main drive shaft assembly. The gear drive train is actuated by a motor that is configured to receive control signals from a robotic system. Various embodiments include a sensor arrangement that operably interfaces the end effector to communicate forces experienced by the end effector to the robotic system.

U.S. Pat. No. 9,086,386, issued to Rutherford et al., discloses an inspection apparatus for nondestructive inspection/evaluation. The inspection apparatus may include a probe, sensor, and a biasing spring. The probe may have a first end and a second, free end defining an opening. The sensor may be received in the opening. The biasing spring may be received in the opening in between the first end of the probe and the sensor to urge the sensor away from the first end of the probe. The probe may be include a gimbal joint or ball and socket type joint and a spindle, where the joint provides for deflection of the prove relative to the spindle. A blocking pin for limiting the range of movement of the sensor retains part of the sensor in the opening. The sensor may have a position extending out of the opening, and a position where an end of the sensor is substantially flush with the end of the probe.

U.S. Pat. No. 10,788,455, issued to Smith et al., discloses an extended reach inspection apparatus may include a scanner device and a robotic manipulator arm. The robotic manipulator arm may include a plurality of arm segments including a distal end arm segment and a proximal end arm segment. A movable joint may couple the distal end arm segment to the robotic manipulator arm. A telescoping extension mechanism may be coupled to the distal end arm segment. The scanner device is mounted to the telescoping extension mechanism for moving the scanner device between a retracted position proximate to the robotic manipulator arm and an extended position at a distance from the robotic manipulator arm. A control handle may be coupled to the proximal end arm segment of the plurality of arm segments for manipulating the robotic manipulator arm.

U.S. Patent Application Publication No.: 2018/0228557, by Darisse et al., discloses a system for performing a medical procedure comprises a first assembly and a second assembly. The first. assembly comprises an articulating probe assembly and a first housing. The articulating probe assembly comprises an outer probe and an inner probe. The outer probe comprises: multiple articulating outer links and a first connector. The inner probe comprises multiple articulating inner links and a second connector. The first housing comprises: a proximal portion; a distal portion; and an opening positioned in the first housing distal portion. The articulating probe is constructed and arranged to pass through the first housing opening. The second assembly comprises: a first carriage constructed and arranged to operably engage the first connector of the outer probe; a second carriage constructed and arranged to operably engage the second connector of the inner probe; a dual linear drive assembly configured to independently translate the first carriage and the second carriage; and a second housing comprising a proximal portion and a distal portion. The first assembly is constructed and arranged to operably attach to the second assembly. Methods of performing a medical procedure are also described.

Chinese Patent No: 202393741U, discloses steel rail welding line cart type defectoscope; It is characterized in that: comprise trolley, tandem scan device (3) and main frame (5); Said trolley comprises handlebar (1), wheel (2) and car body (4), and middle part, said car body (4) bottom surface is provided with tandem scan device (3), and said tandem scan device (3) comprises probe holder (11) and probe (7); Said probe (7) is arranged in probe holder (11) inside, and said main frame (5) is fixed in the top of trolley.

The inventions heretofore known suffer from a number of disadvantages which include: being more efficient, being easier on the body, being faster to use, not requiring other equipment or tools to use, not being hand-held, not allowing one to stand vertically to operate, not being more convenient, not being safter or easier to use, not being versatile.

What is needed is a roofing trolley that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available roofing trolleys. Accordingly, the present invention has been developed to provide a roofing trolley.

In one embodiment invention, there is a roofing trolley that may comprise: a carriage body, that may include: a first pair of wheels that may be spaced apart from each other, and/or positioned and/or sized to support the carriage body; and/or an axle that may be disposed interior to the first pair of wheels; a probe mount that may be coupled to the carriage body interior to the wheels, and/or may include a bracket protruding therefrom; a seam probe that may be functionally coupled to the bracket of the probe mount; a handle that may extend from the carriage body and/or may be in functional communication with the seam probe such that actuation of the handle may actuate pivoting of the seam probe; and/or a hooked knife that may be coupled to the axle.

In other embodiments of the invention the probe mount may be coupled to the axle and/or may be selectably rotatable about the axle. The probe mount may further comprise a collar that may be rotatably disposed about the axle. The probe mount may be fixedly coupled to the axle and/or the axle may be selectably rotatable. The roofing trolley may further comprise a second pair of wheels that may be disposed opposite the first pair of wheels such that the seam probe may be disposed between the first pair and/or the second pair. The seam probe may be oriented laterally and/or may pivot laterally. The bracket may be U-shaped and/or a rear end of the seam probe may be coupled to a first leg of the bracket by a spring and/or a second leg of the bracket by a Bowden cable.

In yet further embodiments of the invention, the first pair of wheels may be the only wheels. The seam probe may be coupled to the handle by a Bowden cable. The seam probe may be disposed below the axle. The roofing trolley may further comprise a second pair of wheels that may be spaced apart from each other, and/or spaced apart from the first pair of wheels; and/or a second axle that may be disposed interior to the first pair of wheels.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side perspective view of a roofing trolley, according to one embodiment of the invention;

FIG. 2 is a partial side perspective view of a roofing trolley showing a carriage body, according to one embodiment of the invention;

FIG. 3 is a top plan view of a roofing trolley, according to one embodiment of the invention;

FIG. 4 is a side elevational view of a weld probe of a roofing trolley with a first wheel removed, according to one embodiment of the invention;

FIG. 5 is a side perspective view of a roofing trolley showing a hooked knife, according to one embodiment of the invention; and

FIG. 6 is a side elevational view of a roofing trolley, according to one embodiment of the invention.

### DETAILED DESCRIPTION OF THE INVENTION

For the purpose of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

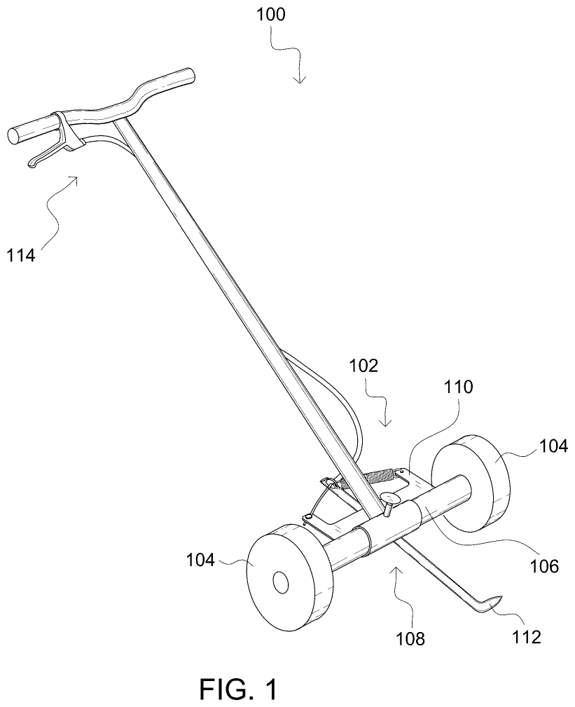

FIG. 1 illustrates a side perspective view of a roofing trolley, according to one embodiment of the invention. There is shown a roofing trolley 100 that includes a carriage body 102. A first pair of wheels 104 are coupled to the carriage body 102 with an axle 106 disposed between the wheels 104. A probe mount 108 is coupled to the axle 106 and includes a bracket 110. A seam probe 112 is disposed within the bracket 110. The roofing trolley 100 also includes a handle 114 coupled to the carriage body 102.

The illustrated roofing trolley 100 may be a utility trolley or cart for moving and transporting tools. For instance, the roofing trolley 100 may be a trolley for moving and using roofing tools such as, but not limited to, knives, hatchets, nailers, shovels, and seam probes. In one non-limiting embodiment, the roofing trolley may be such as a utility trolley wheeled carriage for transport of roofing tools and materials.

As illustrated, the roofing trolley has a carriage body 102. The carriage body 102 may be frame or a structure for carrying tools. Accordingly, tools may be coupled to the carriage body 102 for transport and use. For example, the roofing trolley 100 and carriage body 102 may be such as a body of a 2- or 4-wheeled lawn mower, a paint line striper with wheels, or a wheeled fertilizer spreader.

The illustrated carriage body 102 includes an axle 106 and a first pair of wheels 104. The first pair of wheels 104 are spaced apart from each other and positioned and sized to support the carriage body 102. The axle 106 is disposed interior to the pair of wheels 104. The axle 106 may be a rod or spindle (either fixed or rotating) passing through the center of a wheel or group of wheels. Accordingly, the pair of wheels 104 and axle 106 may be used to lift and move objects coupled to, or disposed on, the carriage body 102. It is further understood that the wheels 104 may be comprised of casters, or any other type of wheel such as complete wheels, cast wheels, flanged wheels, fixed wheels, etc.

Additionally illustrated, a probe mount 108 is shown coupled to the carriage body 102. The probe mount 108 is coupled to the axle 106 and includes a bracket 110 protruding therefrom. A position of the probe mount 108 and bracket 110 may be adjusted both horizontally and vertically along the axle 106. A seam probe 112 may be coupled to the bracket 110 of the probe mount 108. Accordingly, both the probe mount 108 and the bracket 110 may be positioned, sized, and/or shaped for receiving and holding tools in place.

As illustrated, a seam probe 112 is functionally coupled to the bracket 110 of the probe mount 108. The seam probe 112 may be slidably, removably, and adjustably coupled to the bracket 110. The seam probe 112 maybe functionally coupled to the bracket 110 by additional parts and components of the roofing trolley 100. Accordingly, tools, other than seam probes or weld probes, may also be coupled to the probe mount 108.

As shown, a seam probe 112 is coupled to the probe mount 108. The seam probe 112 may be actuated and pivoted for testing and inspecting seams. It is understood that the seam probe 112 may have a really small tip, such as but not limited to a tip diameter of about one-sixteenth of an inch to about one-thirty-second of an inch. It is further understood that the seam probe 112 may have any size and/or shape and/or may be sharp, tapered, rounded, spiked, etc. In one embodiment, the seam probe 112 may be about as sharp as a dull nail lever. For instance, the seam probe 112 may be such as the Seam Probe of Primeline Tools at 3170 Orlando Dr Unit #1, Mississauga, L4V 1R5, Canada, which is incorporated by reference herein.

The illustrated roofing trolley 102 also includes a handle 114 extending from the carriage body 102. The handle 114 may be used for pushing, pulling, driving, controlling, etc. the carriage body 102 along a surface. In one embodiment, the handle 114 may be three feet tall and attached to a cable that is also attached to the axle 106. The handle 114 may also be in functional communication with the seam probe 112 such that actuation of the handle 114 actuates pivoting of the seam probe 112. For example, the handle 114 may actuate pivoting of the seam probe 112 such as a hand brake of a bicycle handle actuates braking of a bicycle such as by attachment to a cable or a strap or a bar for squeezing and actuating swiveling and rotating. In another non-limiting embodiment, the handle actuates a lever and/or lever system that is functionally coupled to the seam probe and thereby pivots the seam probe. Accordingly, the handle 114 may be a squeeze handle and/or may be actuated by squeezing. In one non-limiting embodiment of the invention, the roofing trolley 100 and its parts and components, including the handle 114, may be such as the Striping Paint Machine of ULINE at 12575 Uline Drive, Pleasant Prairie, WI 53158, which is incorporated by reference herein.

In one non-limiting embodiment, there is an axle 106 with a first pair of wheels 104 disposed near opposite ends of the axle 106. A probe mount 108 with a bracket 110 is rotatably coupled to the axle 106. A seam probe 112 is coupled to the bracket 110 of the probe mount 108 opposite the axle 106.

In operation of one embodiment of the invention, the roofing trolley 100 applies a desired amount of pressure to a seam probe 112. A user of the roofing trolley 100 pulls the trolly 100 backwards and squeezes the handle 114 and thereby applies pressure to, and actuates, the seam probe 112 causing the seam probe 112 to move angularly and probe a surface. A position, direction, angle, height, etc. of a seam probe 112 may be adjusted or changed by adjusting a position of an axle 106 or a probe mount 108 along an axle 106. Accordingly, a user of the roofing trolley 100 does not need to bend over and probe by hand.

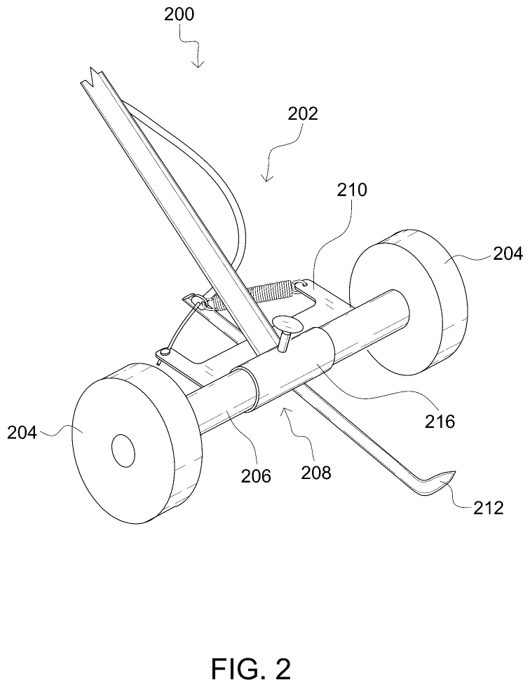

FIG. 2 illustrates a partial side perspective view of a roofing trolley showing a carriage body, according to one embodiment of the invention. The illustrated roofing trolley 200 is shown to include a carriage body 202. A first pair of wheels 204 are coupled to the carriage body 202 along an axle 206. A probe mount 208, including a bracket 210, is coupled to the axle 206 and protrudes therefrom. A seam probe 212 is coupled to the probe mount 208. The probe mount 208 also includes a collar.

As shown, the axle 206 may be rotatable. The axle 206 may be rotatable by a driving power or force such that as the axle rotates, the first pair of wheels 204 also rotate. In one non-limiting embodiment, the illustrated axle 206 may also be selectably rotatable such as by tightening an axle nut with a torque wrench. Accordingly, the axle 206 may be selectably rotatable and the probe mount 208 may be fixedly coupled to the axle 206.

In addition, the illustrated probe mount 208 includes a collar 216, and is selectably rotatable about the axle 206. The collar 216 is fixedly coupled to the probe mount 208 and is selectably rotatable about the axle. Accordingly, the illustrated probe mount 208 is selectably rotatable about the axle 206 such that a height or angle of the bracket 210 protruding from the probe mount 208 may be selected and adjusted. For instance, the bracket 210 may protrude at a variety of angles, such as forty-five degrees from a surface, parallel to a surface, fifty-five degrees to a surface, thirty degrees to a surface, and so on. As shown, the seam probe 212 is disposed below the axle 206.

Further, a circumference of the illustrated bracket 210 may be adjusted to fit a tool. The illustrated bracket 210 may be opened or closed, thereby either increasing or decreasing a circumference of the bracket 210 to achieve a desired size for slidably and removably coupling a tool thereto. For example, the bracket 210 may be opened such that a seam probe 212 may be inserted into the bracket 210. Then, the bracket 210 may be tightened or closure such that the seam probe 212 may be snugly and securely fit within the bracket 210.

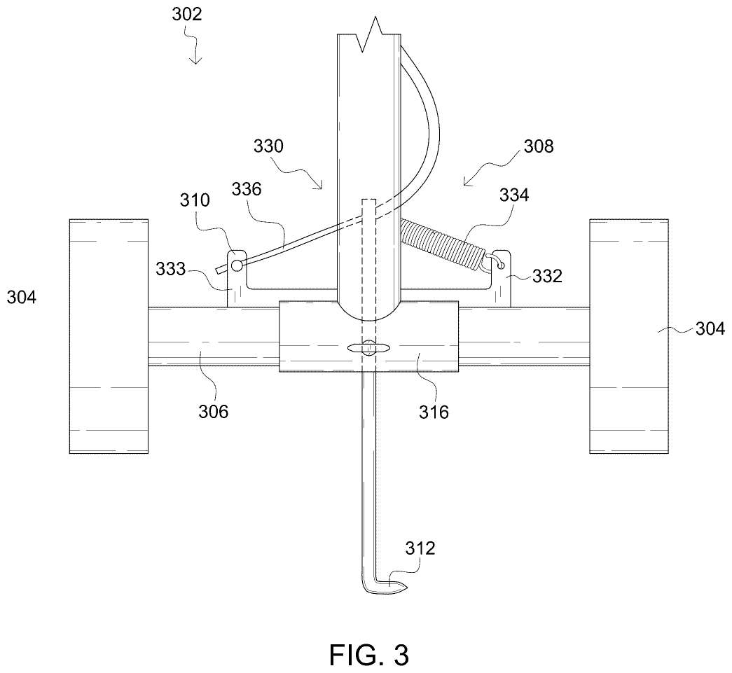

FIG. 3 illustrates a top plan view of a roofing trolley, according to one embodiment of the invention. There is shown a carriage body 302 including a first pair of wheels 304 disposed along an axle 306. The illustrated carriage body 302 also includes a probe mount 308 coupled to the axle 306. The probe mount 308 has a collar 316 with a bracket 310 coupled to the collar 316, and a seam probe 312 coupled to the bracket 310 opposite the collar 316.

As illustrated, the carriage body 302, axle 306, and wheels 304 are sized and shaped to support the various parts and pieces of the roofing trolley (see e.g., FIG. 1, item 100). It is understood that the carriage body 302 may have any size and/or shape such as square, rectangular, round, etc. Further, it is understood that the axle 306 may be cylindrical and may have any length or circumference. It is also understood that the wheels 304 may have any circumference or width for supporting the roofing trolley.

The illustrated axle 306 is shown disposed interior to the carriage body 306, and interior to the first pair of wheels 304. The probe mount 308 is also disposed interior to the first pair of wheels 304. The probe mount 308 is disposed along the axle 306 interior to the wheels 304 so that a tool, such as a seam probe 312, when mounted in the probe mount 308, may be controlled.

As shown, a seam probe 312 is disposed within the bracket 310 of the probe mount 308. The seam probe 312 allows one to inspect roofing seams. Accordingly, the seam probe 312 may be an angled rod that may be pushed downward or laterally. For example, the seam probe 312 may be a ninety-degree angled rod that may have about an inch-long tip. Further shown, the seam probe 312 may be functionally coupled to a swivel point (330, 332, 333, 334, and 336) of the U-Shaped bracket 310.

The illustrated seam probe 312 is oriented laterally and may pivot laterally. It is also understood that the seam probe 312 may be oriented downward and may pivot downward. A rear end 330 of the seam probe 312 is functionally coupled to a first leg 332 of a U-shaped bracket 310 by a spring 334 and to a second leg 333 of the bracket 310 by a Bowden cable 336. The Bowden cable 336. The Bowden cable 336 may be a type of flexible cable used to transmit mechanical force or energy by the movement of an inner cable relative to a hollow outer cable housing. For instance, the Bowden cable 336 may be such as the AGCO 72423831 Bowden Cable by Lindstrom Equipment, Inc. of E6091 578^{th} Ave., Menomonie, WI 54751, which is incorporated by reference herein.

In one embodiment of the invention, a seam probe 312 is coupled to an axle 306. The axle 306 is coupled to a handle (see e.g. FIG. 1, item 114,) that may be a squeeze handle to apply pressure to the probe 312. Accordingly, the handle (see e.g., FIG. 1, item 114) may be a T-bar with a hand lever with a cable on a fulcrum so that applying pressure to the handle (see e.g., FIG. 1, item 114) pushes the seam probe 312 into a seam.

In operation of one embodiment of the invention, an amount of pressure is applied to a handle (see e.g., FIG. 1, item 114) and thereby to the Bowden cable 226 and seam probe 312. The Bowden cable 336 pulls a rear end 330 of the seam probe 312 causing the seam probe 312 to swivel. Accordingly, the seam probe 312 may swivel like a rope on a pulley. A height of the seam probe 312 may by adjusted by adjusting an orientation of the collar 316. Accordingly, the seam probe 312 may pivot back and forth or up and down, depending on the probe's 312 orientation and the pressure applied.

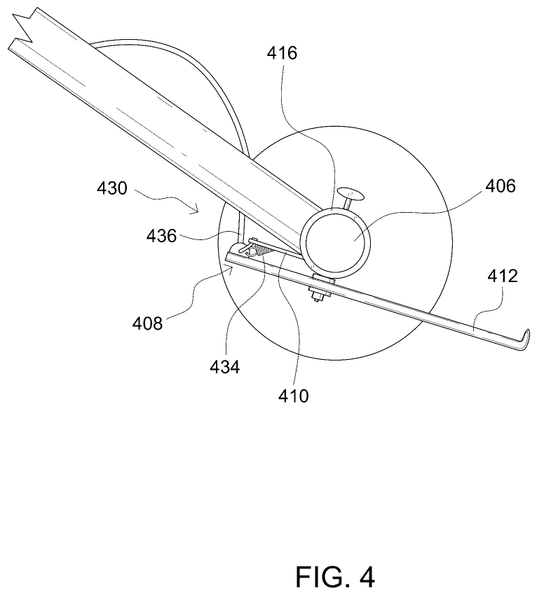

FIG. 4 illustrates a side elevational view of a weld probe of a roofing trolley with a first wheel removed, according to one embodiment of the invention. There is shown an axle 406 with a probe mount 408 coupled to the axle 406. The probe mount 408 includes a U-shaped bracket 410 with a seam probe 412 coupled to the bracket 410.

Further, a rear end 430 of the seam probe 412 is functionally coupled to a first leg (see e.g., FIG. 3, item 332) and a second leg (see e.g., FIG. 3, item 333) of the bracket 410 by a spring 434 and a Bowden cable 436, respectively. In addition, the probe mount 408 is comprised of a collar 416 with the bracket 410 protruding therefrom.

As shown, the collar 416 may be fixedly coupled to the bracket 410 of the probe mount 408. The collar 416 may also be selectably rotatable about the axle 406. Accordingly, a position of the bracket 410, and thereby a position of a tool, such as the seam probe 412, may be adjusted by adjusting the collar 416 of the probe mount 408 and/or the axle 406. Accordingly, the axle 406 and/or the probe mount 408 may be positioned so that the seam probe 412 is oriented laterally and pivots laterally.

Also shown, the bracket 410 is U-shaped. It is understood that the bracket 410 may have any size and/or shape for functionally coupling to the seam probe 412, spring 434, and Bowden cable 436. For example, the bracket may be U-shaped, C-shaped, V-shaped, or have any other shape with a first leg (see e.g. FIG. 3, item 332) and a second leg (333.

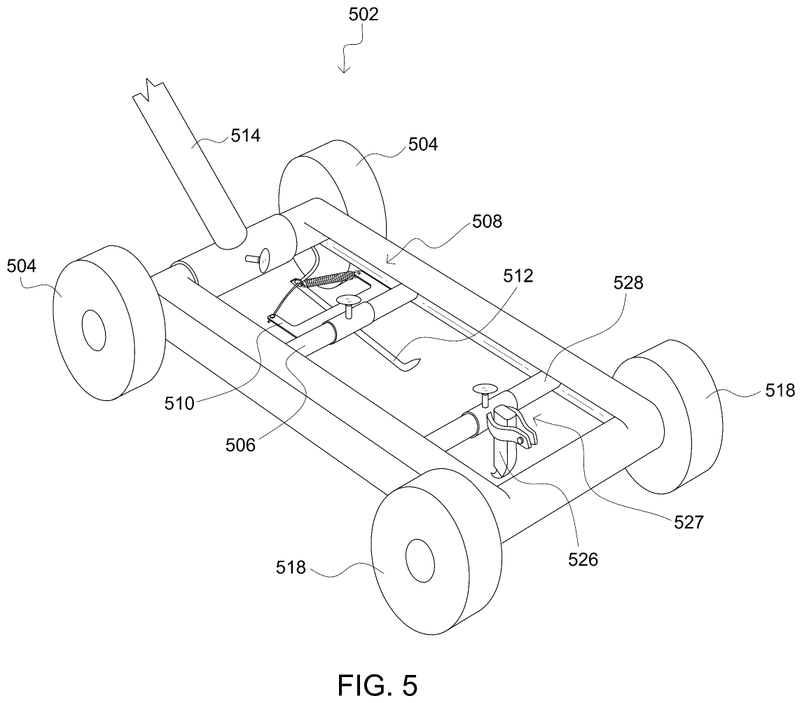

FIG. 5 illustrates a side perspective view of a roofing trolley showing a hooked knife, according to one embodiment of the invention. There is shown a carriage body 502. The illustrated carriage body 502 includes a first pair of wheels 504 spaced apart from each other and a first axle 506 disposed interior to the first pair of wheels 504. The illustrated carriage body 502 also includes a second pair of wheels 518 spaced apart from each other and spaced apart from the first pair of wheels 504, and a second axle 528 disposed interior to the second pair of wheels 518. A probe mount 508 is shown coupled to the first axle 506 with a bracket 510 protruding from the probe mount 508. In addition, a seam probe 512 is functionally coupled to the bracket 510 of the probe mount 508, in functional communication with the handle 514. Further, a hooked knife 526 is coupled to a knife mount 527 protruding from the second axle 528.

As illustrated, one embodiment of the roofing trolley may have two pairs of wheels (504 and 518), each disposed on separate axles (506 and 528, respectively), all coupled to the carriage body 502. Accordingly, the carriage body 502 may be such as a frame for an automobile, a lawn mower, or a stroller. For instance, the carriage body 502 may be such as a frame of the 60V Max 22 in. (56 cm) Recycler Personal Pace Auto-Drive lawn mower by The Toro Company of 8111 Lyndale Avenue South, Bloomington, MB 55420-1196, which is incorporated by reference herein.

Additionally, the roofing trolley may have two separate tools (512 and 526) each coupled to a separate axle (506 and 528) by separate mounts (508 and 527). For example, as shown, the roofing trolley may have a seam probe 512 coupled to the first axle 506 and a hooked knife 526 coupled to the second axle 528. It is understood that the roofing trolley may have any number and any type of tool coupled to the mounts (508 and 527), such as roofing tools. Further, it is understood that any type of roofing supply may be coupled to the roofing trolley, such as shingles.

The illustrated roofing trolley has a seam probe 512 and a hooked knife 526 coupled to its carriage body 502. As shown, it is understood that the hooked knife 526 may be a blade for cutting shingles. Accordingly, the hooked knife 526 may have a blade that is shaped and sized for cutting and trimming. For instance, the hooked knife 526 may be such as the Hook Knife BG101 by Pittsburgh Spray Equipment Co. of 3601 Library Rd., Pittsburgh, Pa 15234, which is incorporated by reference herein. As further illustrated, the hooked knife 526 is oriented to cut in the same direction as the handle 514. For example, in one embodiment of the invention, as the handle (see e.g., FIG. 1, item #114) is pulled in a backwards direction, the knife 526 will cut in a backwards direction.

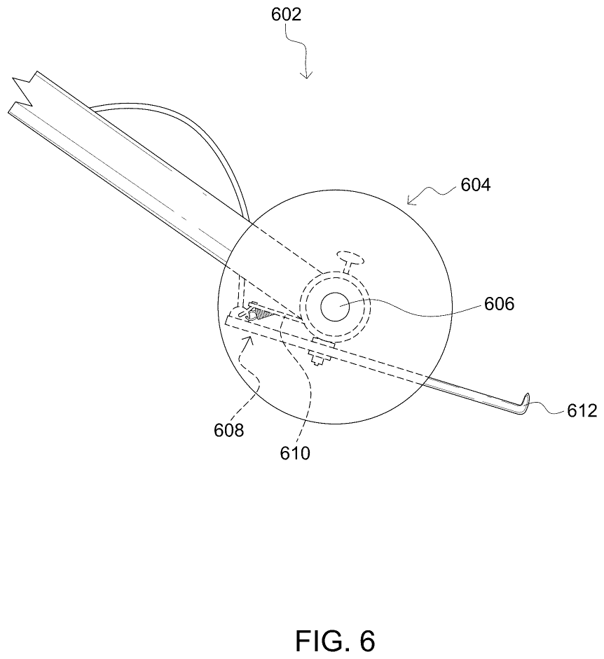

FIG. 6 illustrates a side elevational view of a roofing trolley, according to one embodiment of the invention. There is shown a carriage body 602 with a pair of wheels 604 coupled thereto. The carriage body 602 also has an axle 606 disposed interior to the pair of wheels 604. A probe mount 608 is coupled to the axle 606 and includes a bracket 610 with a seam probe 612 coupled thereto. Accordingly, the axle 606 is in plane with an axis of the wheels 604.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate the seam probe extending from the rear of the axle, it is understood that the seam probe may protrude from a front of the axle or downward from the axle. The seam probe may also be pre-made/and or welded onto the carriage body.

It is also envisioned that the handle may include any type of device for actuating the probe, such as a lever, a squeeze handle, a trigger, or a button. Further, it is understood that the seam probe actuation device may be placed anywhere along the handle.

It is expected that there could be numerous variations of the design of this invention. An example is that the roofing trolley may be any size and/or may be custom-fit to a user. It is also understood that the roofing trolley may include weights disposed about the trolley, or that the trolley components may be comprised of weighted materials, in order to add weight to different portions of the trolley to assist with ease of use. For example, in one embodiment, the roofing trolley may include about thirty pounds per square inch of extra weight to apply pressure to the seam probe. As another example, the roofing trolley may include a marker to mark weak spots tested by the weld probe so that one knows which spots to come back to and fix.

Finally, it is envisioned that the components of the device may be constructed of a variety of materials, such as, but not limited to: metal, rubber, plastic, and wood.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A roofing trolley, comprising:
a. a carriage body, including:
i. a first pair of wheels spaced apart from each other, and positioned and sized to support the carriage body; and
ii. an axle disposed interior to the first pair of wheels;
b. a probe mount coupled to the carriage body interior to the wheels, and including a bracket protruding therefrom;
c. a seam probe functionally coupled to the bracket of the probe mount; and
d. a handle extending from the carriage body and in functional communication with the seam probe such that actuation of the handle actuates pivoting of the seam probe.

2. The roofing trolley of claim 1, wherein the probe mount is coupled to the axle and is selectably rotatable about the axle.

3. The roofing trolley of claim 2, wherein the probe mount further comprises a collar rotatably disposed about the axle.

4. The roofing trolley of claim 1, wherein the probe mount is fixedly coupled to the axle and the axle is selectably rotatable.

5. The roofing trolley of claim 1, further comprising a second pair of wheels disposed opposite the first pair of wheels such that the seam probe is disposed between the first pair and the second pair.

6. The roofing trolley of claim 1, wherein the seam probe is oriented laterally and pivots laterally.

7. The roofing trolley of claim 6, wherein the bracket is U-shaped and a rear end of the seam probe is coupled to a first leg of the bracket by a spring and a second leg of the bracket by a Bowden cable.

8. The roofing trolley of claim 1, wherein the first pair of wheels are the only wheels.

9. The roofing trolley of claim 1, wherein the seam probe is coupled to the handle by a Bowden cable.

10. The roofing trolley of claim 1, wherein the seam probe is disposed below the axle.

11. A roofing trolley, comprising:
a. a carriage body, including:
i. a first pair of wheels spaced apart from each other, and positioned and sized to support the carriage body; and
ii. an axle disposed interior to the first pair of wheels;
b. a probe mount coupled to the carriage body interior to the wheels, and including a bracket protruding therefrom, wherein the probe mount is selectably rotatable;
c. a seam probe functionally coupled to the bracket of the probe mount;
d. a handle extending from the carriage body and in functional communication with the seam probe such that actuation of the handle
actuates pivoting of the seam probe; and
e. a hooked knife coupled to the axle.

12. The roofing trolley of claim 11, wherein the probe mount is coupled to the axle and is selectably rotatable about the axle.

13. The roofing trolley of claim 12, wherein the probe mount further comprising a collar rotatably disposed about the axle.

14. The roofing trolley of claim 11, wherein the probe mount is fixedly coupled to the axle and the axle is selectably rotatable.

15. The roofing trolley of claim 11, further comprising a second pair of wheels disposed opposite the first pair of wheels such that the axle is disposed between the first pair and the second pair.

16. The roofing trolley of claim 11, wherein the seam probe is oriented laterally and pivots laterally.

17. The roofing trolley of claim 16, wherein the bracket is U-shaped and a rear end of the seam probe is coupled to a first leg of the bracket by a spring and a second leg of the bracket by a Bowden cable.

18. The roofing trolley of claim 11, wherein the seam probe is coupled to the handle by a Bowden cable.

19. The roofing trolley of claim 11, wherein the seam probe is disposed below the axle.

20. A roofing trolley, comprising:
a. a carriage body, including:
i. a first pair of wheels spaced apart from each other, and positioned and sized to support the carriage body;
ii. a first axle disposed interior to the first pair of wheels;
iii. a second pair of wheels spaced apart from each other, and spaced apart from the first pair of wheels; and
iv. a second axle disposed interior to the second pair of wheels;
b. a knife mount coupled to the second axle;
c. a hooked knife coupled to the knife mount;
d. a probe mount coupled to the carriage body interior to the first pair of wheels, coupled to the first axle and selectably rotatable about the first axle, and including a collar rotatably and selectably coupled to the first axle, the collar including a U-shaped bracket protruding therefrom;
e. a seam probe functionally coupled to the U-shaped bracket of the probe mount, wherein the seam probe is oriented laterally and pivots laterally; and
f. a handle extending from the carriage body and in functional communication with the seam probe such that actuation of the handle actuates pivoting of the seam probe, wherein the seam probe is coupled to the handle by a Bowden cable.
